(19) United States
(12) Patent Application Publication
(10) Pub. No.: US 2025/0224103 A1
(43) Pub. Date: Jul. 10, 2025

(54) Roof-Mounted Emergency Beacon

(71) Applicant: Todd Allen Helber, MOUNT GILEAD, OH (US)

(72) Inventor: Todd Allen Helber, MOUNT GILEAD, OH (US)

(21) Appl. No.: 19/013,995

(22) Filed: Jan. 8, 2025

Related U.S. Application Data
(60) Provisional application No. 63/618,601, filed on Jan. 8, 2024.

(51) Int. Cl. F21V 21/22; F21S 10/02; F21S 10/06; F21V 21/15; F21Y 113/10; G08B 5/38

(52) U.S. Cl. CPC F21V 21/22; F21S 10/02; F21V 21/15; G08B 5/38; F21S 10/06; F21Y 2113/10

(57) ABSTRACT

A roof-mounted emergency beacon used to alert emergency responders and observers of the location of an emergency. The beacon is activated by a smoke alarm, burglar alarm, or medical emergency alarm. Upon activation, the beacon light flashes, and the beacon extends to increase visibility. The beacon illuminates different colors to indicate different types of emergencies. Upon deactivation, the beacon lowers to return to the stowed position.

### FIELD OF THE INVENTION

The present invention relates generally to beacon lights. The present invention relates more specifically to emergency locator beacons.

### BACKGROUND OF THE INVENTION

When an emergency occurs, it is critical to direct resources to the location of the emergency as quickly as possible. Typically, emergency responders are given the address of the emergency and must find the location of the emergency visually. In some cases, the address of the building is not displayed properly, delaying responders from finding the location of the emergency.

It is an objective of the present invention to direct attention to the building where an emergency is occurring. It is a further objective of the invention to provide a beacon that will direct emergency responders to the building. It is a further objective of the present invention to inform the public of an emergency at the building.

### SUMMARY OF THE INVENTION

The present invention provides an apparatus for a roof-mounted emergency beacon. The roof-mounted emergency beacon is used to alert emergency responders and observers of the location of an emergency. The beacon is activated by a smoke alarm, burglar alarm, or medical emergency alarm. Upon activation, the beacon light flashes, and the beacon extends to increase visibility. The beacon illuminates different colors to indicate different types of emergencies. Upon deactivation, the beacon lowers to return to the stowed position.

### BRIEF DESCRIPTION OF THE DRAWINGS

FIG. 1 is a perspective view of Embodiment 1 of the present invention in a first configuration.

FIG. 2 is a perspective view of Embodiment 1 of the present invention in the first configuration.

FIG. 3 is a front elevation view of Embodiment 1 of the present invention in the first configuration.

FIG. 4 is a right-side elevation view of Embodiment 1 of the present invention in the first configuration, showing a plane 5-5 upon which a sectional view is taken and shown in FIG. 5.

FIG. 5 is a sectional view of Embodiment 1 of the present invention in the first configuration, taken along line 5-5 of FIG. 4.

FIG. 6 is a perspective view of Embodiment 1 of the present invention in a second configuration.

FIG. 7 is a front elevation view of Embodiment 1 of the present invention in the second configuration.

FIG. 8 is a right-side view of Embodiment 1 of the present invention in the second configuration.

FIG. 9 is a block diagram of Embodiment 1 of the present invention.

### DETAILED DESCRIPTION OF THE INVENTION

All illustrations of the drawings are for the purpose of describing selected versions of the present invention and are not intended to limit the scope of the present invention.

The present invention represents an emergency beacon that is mounted to the exterior of a building. The emergency beacon emits light to inform observers of an emergency and to direct emergency responders to the building. The emergency beacon may be raised to increase visibility.

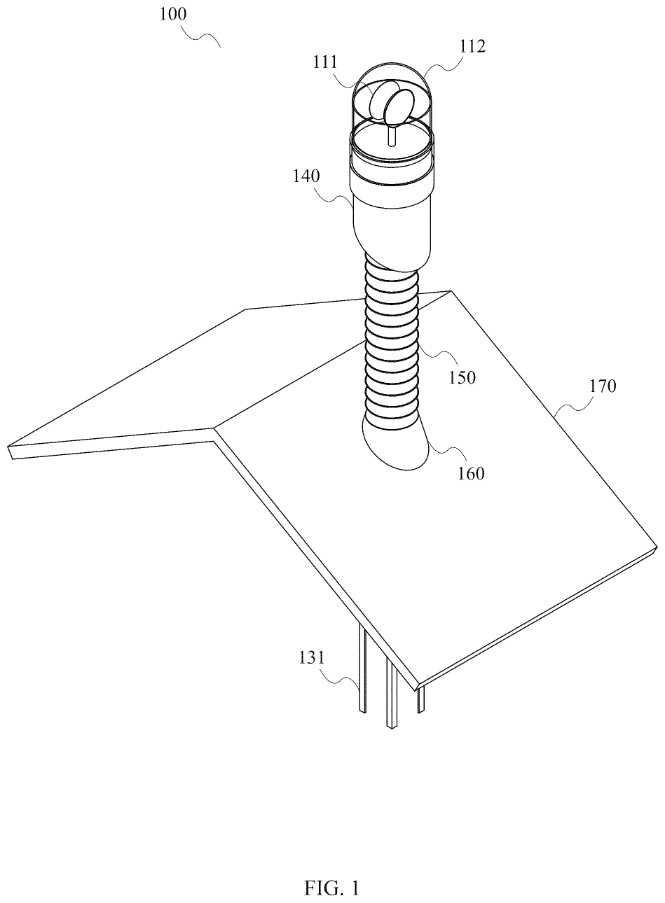

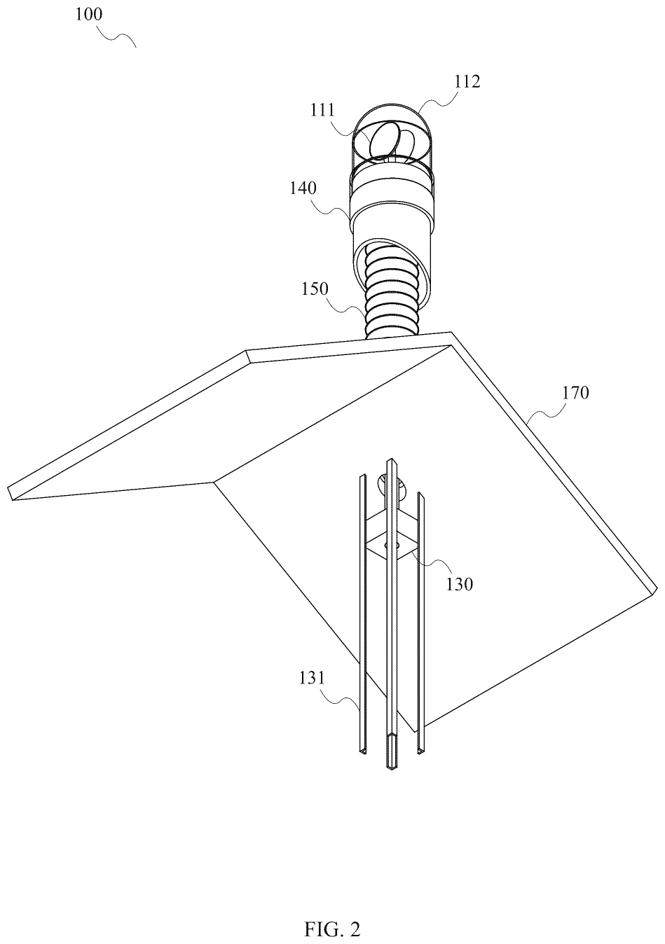

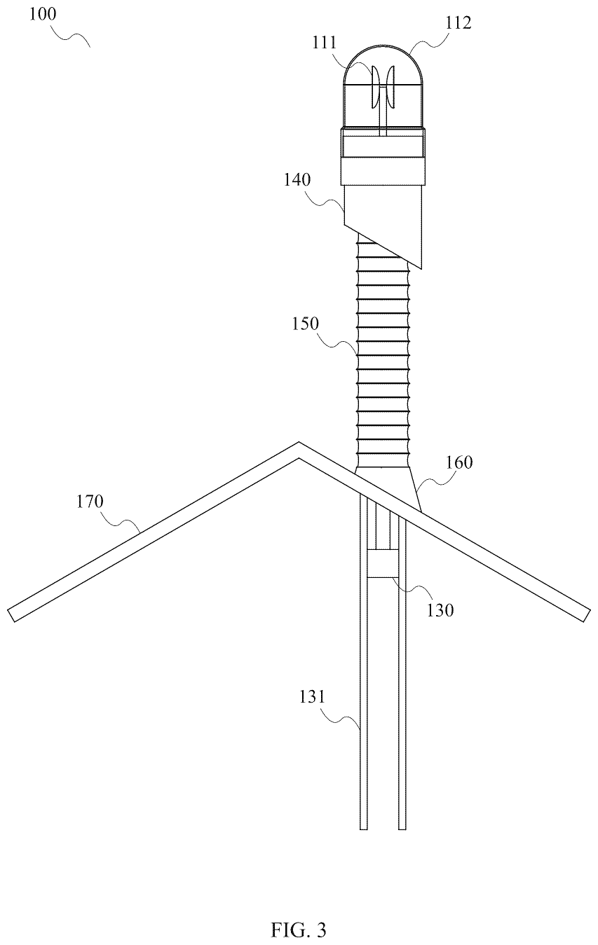

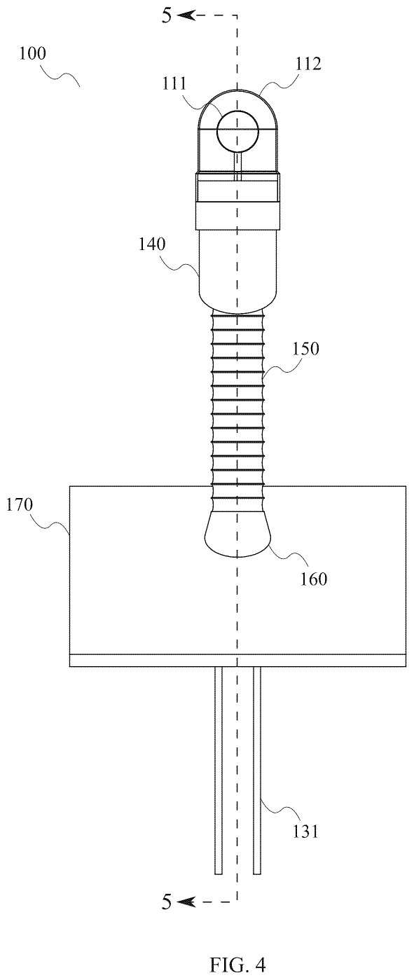

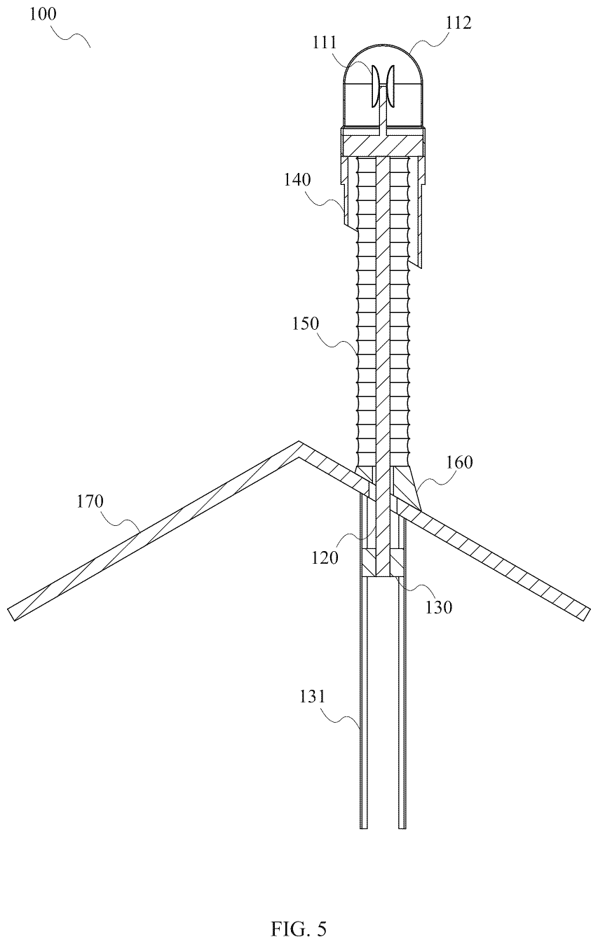

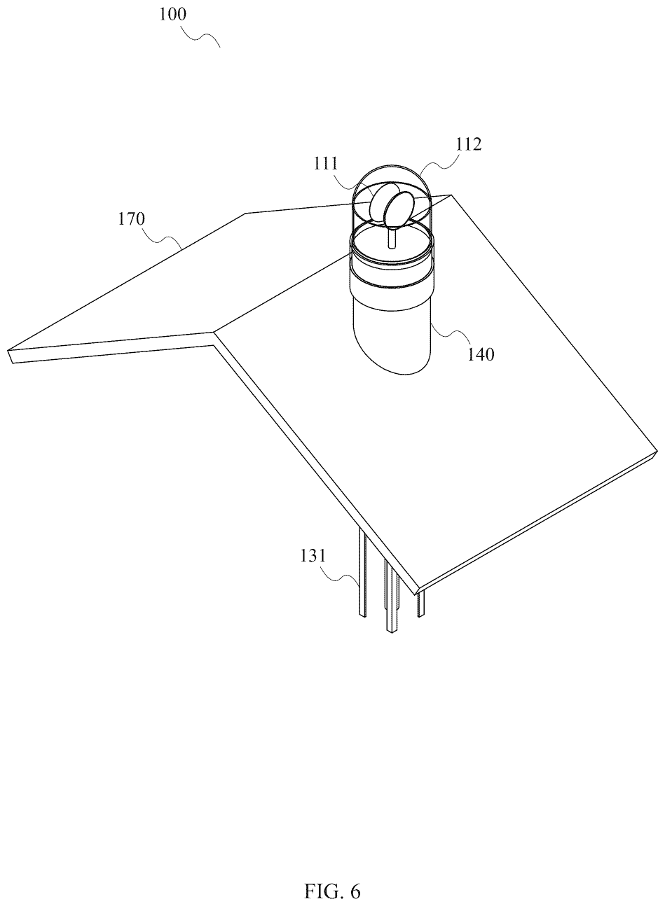

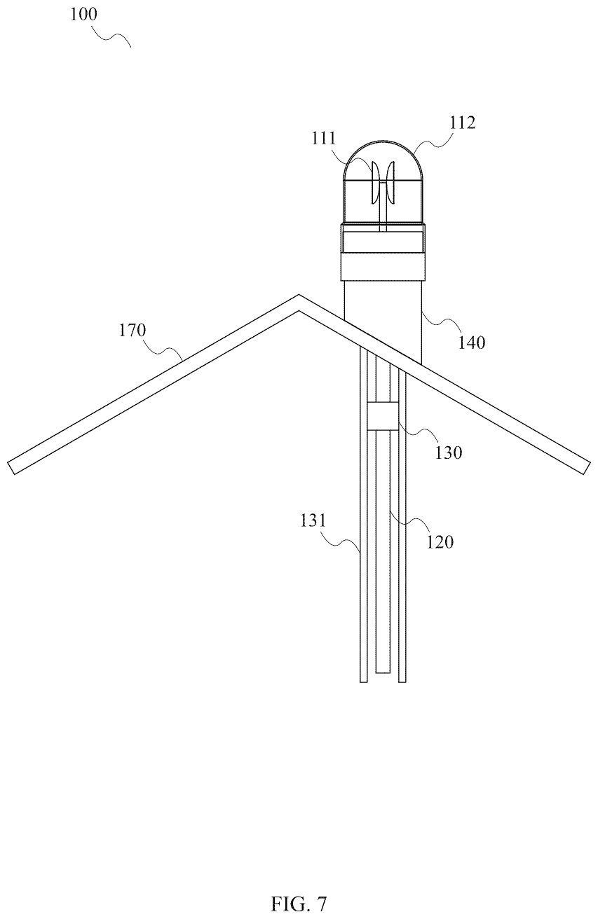

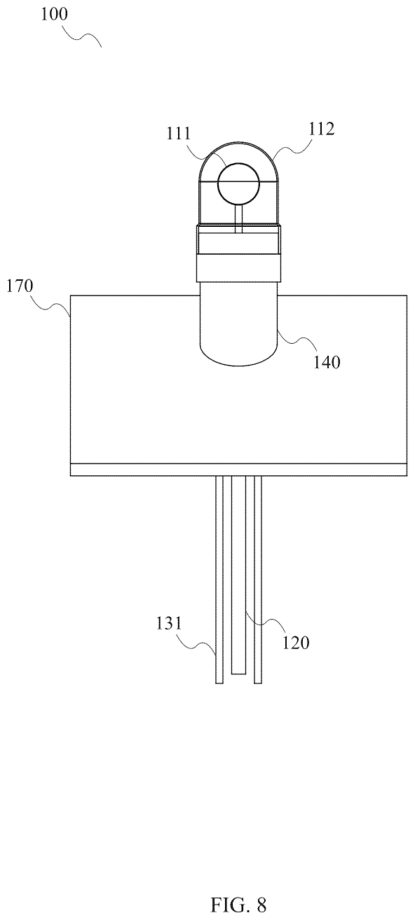

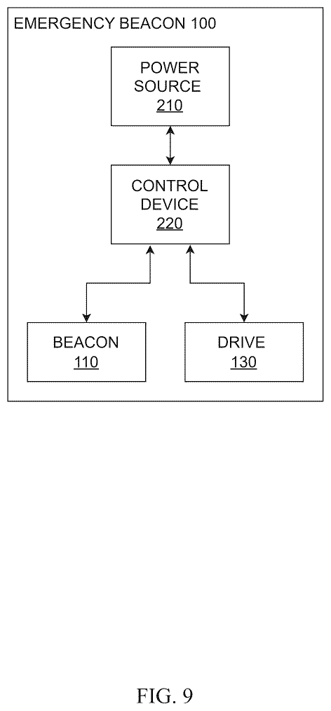

Referring to FIGS. 1-9, Embodiment 1 of the present invention represents an emergency beacon 100. The emergency beacon 100 comprises a beacon 110, a shaft 120, a drive 130, a collar 140, an expanding cover 150, a roof mount 160, a power source 210, and a control device 220. In Embodiment 1, the emergency beacon 100 is mounted to a roof 170.

The beacon 110 comprises a beacon light 111 and a dome 112. The beacon light 111 comprises a light that may be illuminated in different colors. For example, the beacon light 111 contains red, green, and blue lights capable of combining to display any color of light. In another example, the beacon light 111 contains a light for each color that can be displayed. In Embodiment 1, the beacon light 111 illuminates with a red color to indicate a fire emergency. In Embodiment 1, the beacon light 111 illuminates with a blue color to indicate a police emergency, such as a burglary. In Embodiment 1, the beacon light 111 illuminates with a yellow color to indicate a flood emergency. In Embodiment 1, the beacon light 111 illuminates with a white light to indicate a medical emergency. In some embodiment, the beacon light 111 may spin within the dome 112 to create a flashing effect to observers. In other embodiments, the beacon light 111 illuminates intermittently to create the flashing effect. The beacon light 111 is mounted within the dome 112. The dome 112 provides protection from the weather. In Embodiment 1, the dome 112 is made from a transparent or translucent material, such that the light emitted from the beacon light 111 is visible through the dome 112.

The beacon 110 is mounted to the top of the shaft 120. The shaft 120 is mechanically connected to the drive 130. In Embodiment 1, gears inside the drive 130 engage with teeth on the shaft. The drive 130 is mounted to a support frame 131. The drive 130 raises and lowers the shaft 120 to raise and lower the beacon 110. As the drive 130 raises the shaft 120, the shaft 120 passes through the roof mount 160. The roof mount 160 provides an opening for the shaft 120 to pass through the roof 170. The collar 140 covers and protects the connection between the beacon 110 and the shaft 120. The expanding cover 150 covers and protects the shaft 120 when the beacon 110 is in the extended position. The top end of the expanding cover 150 connects to the collar 140, and the bottom end of the expanding cover 150 connects to the roof mount 160. When the beacon 110 is in the stowed position, the expanding cover 150 is stored inside the collar 140.

In Embodiment 1, the roof 170 is a slanted roof. For example, the roof 170 may be the roof of a residence. In other embodiments, the roof may be flat. For example, the roof may be the roof of a commercial building.

The power source 210 provides electricity to the emergency beacon 100. The control device 220 controls the beacon 110 and the drive 130. The emergency beacon 100 further contains wiring necessary to power and control the various components. In some embodiments, the control device 220 includes a control panel. In some embodiments, the control device 220 connects wirelessly to a mobile device. In some embodiments, the control device 220 is connected to smoke detectors in the building. In some embodiments, the control device 220 is connected to fire alarms in the building. In some embodiments, the control device 220 is connected to break-in alarms in the building. In some embodiments, the control device 220 is connected to a medical emergency alarm. Upon activation of the control device 220, the control device 220 activates the beacon 110 to illuminate and activate the drive 130 to raise the shaft. For example, when a user inputs a fire emergency into the control device 220, the control device 220 activates the beacon 110 to illuminate a red light and activates the shaft to raise the beacon 110. Upon deactivation, the control device 220 deactivates the beacon 110 and activates the drive 130 to lower the beacon 110.

Although the invention has been explained in relation to its preferred embodiment, it is to be understood that many other possible modifications and variations can be made without departing from the spirit and scope of the invention as hereinafter claimed.

What is claimed is:

1. An emergency beacon, comprising:
a beacon light;
a shaft;
a drive;
the beacon light mounted to the shaft; and
the shaft mechanically connected to the drive.

2. The emergency beacon of claim 1, further comprising:
an expanding cover;
a collar;
the expanding cover surrounding a distal portion of the shaft; and
the collar connected to a bottom surface of the beacon light.

3. The emergency beacon of claim 1, wherein the drive raises the shaft in a vertical direction.

4. The emergency beacon of claim 1, further comprising:
a roof mount; and
the roof mount connected to a roof.

5. The emergency beacon of claim 4, wherein:
the shaft traverses the roof; and
the shaft traverses the roof mount.

6. The emergency beacon of claim 1, wherein the beacon light is configured to emit a plurality of colors.

7. The emergency beacon of claim 6, wherein:
a first color of the plurality of colors comprises a red color; and
the beacon light emitting the red color to indicate a fire emergency.

8. The emergency beacon of claim 6, wherein:
a second color of the plurality of colors comprises a blue color; and
the beacon light emitting the blue color to indicate a police emergency.

9. The emergency beacon of claim 6, wherein:
a third color of the plurality of colors comprises a yellow color; and
the beacon light emitting the yellow color to indicate a flood emergency.

10. The emergency beacon of claim 6, wherein:
a fourth color of the plurality of colors comprises a white color; and
the beacon light emitting the white color to indicate a medical emergency.

11. An emergency beacon, comprising:
a beacon light;
a collar;
a shaft
a drive
an expanding cover;
the beacon light mounted to an upper end of the shaft;
the shaft mechanically connected to the drive;
the expanding cover surrounding an upper portion of the shaft; and
the collar connected to a bottom surface of the beacon light.

12. The emergency beacon of claim 11, wherein the drive raises the shaft in a vertical direction.

13. The emergency beacon of claim 11, further comprising:
a roof mount; and
the roof mount connected to a roof.

14. The emergency beacon of claim 13, wherein:
the shaft traverses the roof mount; and
the shaft traverses the roof mount.

15. The emergency beacon of claim 11, wherein the beacon light is configured to emit a plurality of colors.

16. The emergency beacon of claim 15, wherein:
a first color of the plurality of colors comprises a red color;
a second color of the plurality of colors comprises a blue color;
a third color of the plurality of colors comprises a yellow color;
a fourth color of the plurality of colors comprises a white color;
the beacon light emitting the red color to indicate a fire emergency;
the beacon light emitting the blue color to indicate a police emergency;
the beacon light emitting the yellow color to indicate a flood emergency; and
the beacon light emitting the white color to indicate a medical emergency.

17. An emergency beacon comprising:
a beacon light;
a collar;
a shaft;
a drive;
an expanding cover;
a roof mount;
the beacon light mounted to an upper end of the shaft;
the shaft mechanically connected to the drive;
the expanding cover surrounding an upper portion of the shaft;
the collar connected to a bottom surface of the beacon light;
the roof mount connected to a roof;
the shaft traversing the roof; and
the shaft traversing the roof mount.

18. The emergency beacon of claim 17, wherein the drive raises the shaft in a vertical direction.

19. The emergency beacon of claim 17, wherein the beacon light is configured to emit a plurality of colors.

20. The emergency beacon of claim 17, wherein:
a first color of the plurality of colors comprises a red color;
a second color of the plurality of colors comprises a blue color;
a third color of the plurality of colors comprises a yellow color;
a fourth color of the plurality of colors comprises a white color;
the beacon light emitting the red color to indicate a fire emergency;
the beacon light emitting the blue color to indicate a police emergency;
the beacon light emitting the yellow color to indicate a flood emergency; and
the beacon light emitting the white color to indicate a medical emergency.
